(19) United States
(12) Patent Application Publication
(10) Pub. No.: US 2025/0340092 A1
(43) Pub. Date: Nov. 6, 2025

(54) JACKKNIFE DETERRENT SYSTEM FOR A VEHICLE

(71) Applicant: Honda Motor Co., Ltd., Tokyo (JP)

(72) Inventors: Joshua D. Pritchard, Worthington, OH (US); Casey R. Burkhart, Marysville, OH (US); Matthew DJ Taylor, Westerville, OH (US); Michael P. Hullihan, Dublin, OH (US); Justin E. Crone, Bellefontaine, OH (US); Michael G. Kaiser, North Lewisburg, OH (US)

(21) Appl. No.: 18/656,334

(22) Filed: May 6, 2024

(51) Int. Cl. B60D 1/64; B60D 1/30; B60R 1/00

(52) U.S. Cl. CPC B60D 1/64; B60D 1/30; B60R 1/003

(57) ABSTRACT

A jackknife deterrent system, for a towing vehicle configured to be connected to a trailer, includes at least one sensor configured to detect a distance between the towing vehicle and the trailer, and a controller communicatively coupled to the at least one sensor and a rear steering system of the towing vehicle. The controller is configured to monitor the distance between the towing vehicle and the trailer based on input received from the at least one sensor. The controller is further configured to control the rear steering system to keep the distance between the towing vehicle and the trailer equal to or above a first threshold distance value during turning of the towing vehicle relative to the trailer.

### BACKGROUND

The disclosed subject matter relates generally to a towing vehicle. More particularly, the disclosed subject matter relates to a jack knife deterrent system to prevent a jackknifing of the towing vehicle and trailer towed by the towing vehicle.

Jack knifing of a tow-trailer, sometimes happens during turning or reversing. Jack knifing is a known situation where a trailer behind a vehicle reaches an angle where the trailer touches or nearly touches the vehicle. Various systems exist within the industry to help prevent jack knife of trailers. Furthermore, vehicles that include both front wheel steering and rear wheel steering are also known. However, known jack knife prevention systems do not control rear wheel steering and also do not allow for variation in the degree of trailer movement.

### SUMMARY

In accordance with one embodiment of the present disclosure, a jackknife deterrent system for a towing vehicle is disclosed. The towing vehicle is configured to be connected to a trailer and includes a rear steering system to steer rear wheels of the towing vehicle. The jackknife deterrent system includes at least one sensor configured to detect a distance between the towing vehicle and the trailer, and a controller communicatively coupled to the at least one sensor and the rear steering system of the towing vehicle. The controller is configured to monitor the distance between the towing vehicle and the trailer based on input received from the at least one sensor. The controller is further configured to control the rear steering system to control the steering of the rear wheels to keep the distance between the towing vehicle and the trailer equal to or above a first threshold distance value during turning of the towing vehicle relative to the trailer.

In accordance with another embodiment of the present disclosure, a towing vehicle is provided. The towing vehicle is configured to be connected to a trailer to tow the trailer and includes a rear steering system to steer rear wheels of the towing vehicle, and at least one sensor configured to detect a distance between the towing vehicle and the trailer. The towing vehicle also includes a controller communicatively coupled to the at least one sensor and the rear steering system and is configured to monitor the distance between the towing vehicle and the trailer based on input received from the at least one sensor. The controller is further configured to control the rear steering system to control the steering of the rear wheels to keep the distance between the towing vehicle and the trailer equal to or above a first threshold distance value during turning of the towing vehicle relative to the trailer.

In accordance with yet a further embodiment of the present disclosure, a method for preventing a jackknifing of a towing vehicle and a trailer connected to the towing vehicle is provided. The method includes detecting, by at least one sensor, a distance between the towing vehicle and the trailer, and monitoring, by a controller, the distance between the towing vehicle and the trailer based on input received from the at least one sensor. The method further includes controlling a rear steering system of the towing vehicle to control the steering of rear wheels of the towing vehicle to keep the distance between the towing vehicle and the trailer equal to or above a first threshold distance value during turning of the towing vehicle relative to the trailer.

### BRIEF DESCRIPTION OF THE DRAWINGS

Certain embodiments of the present disclosure will be better understood from the following description taken in conjunction with the accompanying drawings in which:

FIG. 1 is a schematic top view of a towing vehicle and a trailer, in accordance with one embodiment of the present disclosure; and

FIG. 2 is a block diagram of the towing vehicle of FIG. 1 and schematically depicting various components of the towing vehicle, in accordance with one embodiment of the present disclosure.

### DETAILED DESCRIPTION OF EXEMPLARY EMBODIMENTS

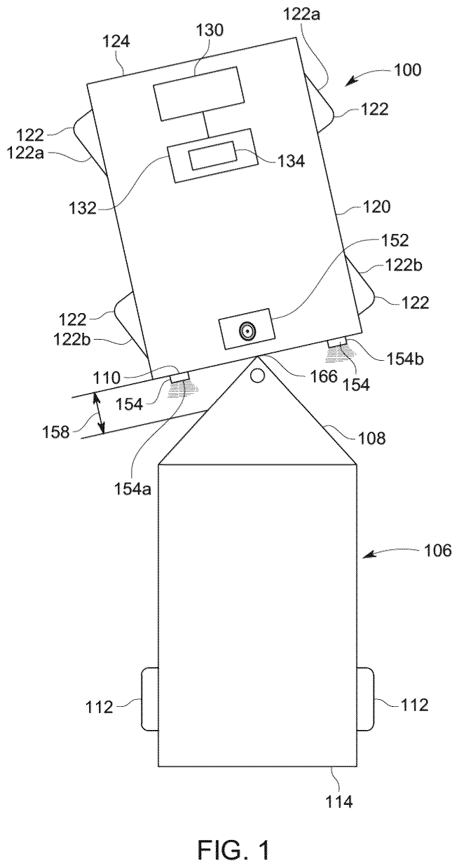

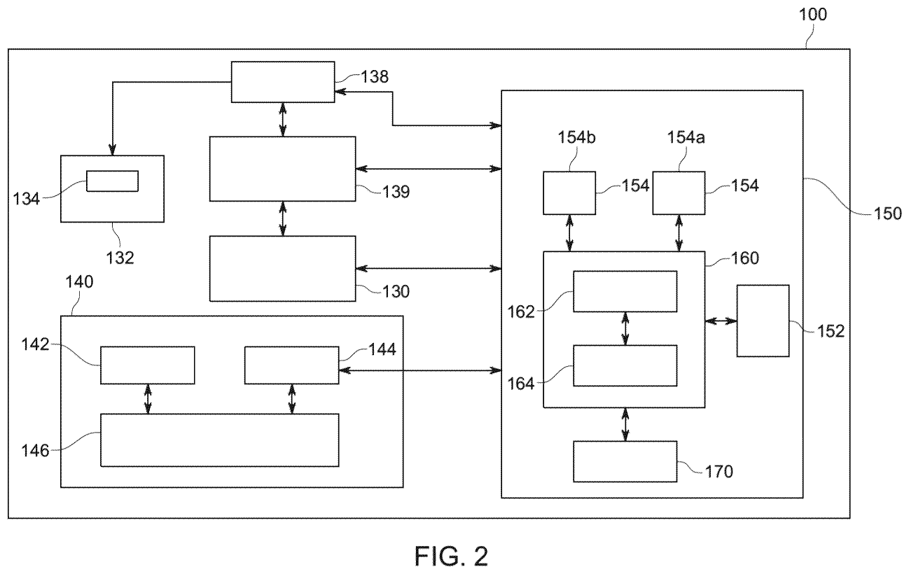

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 illustrates a schematic top view of a vehicle (also referred to as towing vehicle), indicated generally at 100, coupled to a trailer 106, in accordance with one embodiment of the present disclosure. FIG. 2 is a block diagram of a vehicle, for example, the vehicle 100 shown in FIG. 1. The trailer 106 is removably coupled to the vehicle 100, using known couplers, for example, a trailer hitch that includes a ball mount. The trailer 106 is pivotally attached to the towing vehicle 100 and configured to pivot about a vertical axis that extends substantially perpendicularly to a ground surface. As shown, the trailer 106 extends rearwardly of the towing vehicle 100 and includes a front end portion 108 hinged/hitched to a rear end portion 110 of the towing vehicle 100 and a plurality of trailer wheels 112 arranged proximate to a rear end 114 of the trailer 106, supporting the trailer 106 on the ground surface.

The towing vehicle 100 is configured to move the trailer 106 and includes a vehicle body 120 supporting various components of the towing vehicle 100 and a plurality of wheels 122 supporting the vehicle body 120 on the ground surface and enables a movement of the towing vehicle 100 on the ground surface. As shown, the plurality of wheels 122 includes a pair of front wheels 122a arranged proximate to a front end 124 of the towing vehicle 100 and a pair of rear wheels 122b arranged proximate to the rear end 110 of the towing vehicle 100.

To power the towing vehicle 100 and to enable the movement of the wheels 122 over the ground surface, the towing vehicle 100 includes a power source 130 operatively coupled to the wheels 122. The power source 130 may include an internal combustion engine, an electric motor and at least one battery, and/or any other propulsion system for a vehicle. To transmit the power from the power source 130 to one or more of the plurality of wheels 122, the towing vehicle 100 includes a drivetrain 132 operatively coupling the power source 130 to one or more of the plurality of wheels 122. In an embodiment, the drivetrain 132 may include a transmission 134 that facilitates a transfer of a desired torque and a desired speed to the traction wheels 122. Further, transmission 134 facilitates/enables the movement/travel of the towing vehicle 100 in a forward direction and reverse direction. To enable the movement of the towing vehicle 100 and hence the trailer 106 in the reverse direction i.e., reversing of the towing vehicle 100 or the forward direction in a desired gear ratio, the towing vehicle 100 includes a gear selector 138 adapted be moved/displaced between a plurality of positions or selections including a reverse position to enable the movement of the towing vehicle 100 in the reverse direction.

In an embodiment, a power source 130 of the towing vehicle 100 is adapted to be operated into a plurality of modes, for example, tow-trailer mode, sports mode, eco mode, etc., and includes a mode selector 139 to enable the driver to select a desired operating mode of the power source 130 i.e., towing vehicle 100. It may be appreciated that the driver of the towing vehicle 100 may manually select the tow trailer mode when a trailer is connected to the towing vehicle 100. In some embodiments, a controller automatically detects a coupling of the trailer 106 to the towing vehicle 100 and automatically selects the tow-trailer mode to operate the power source 130 i.e., the towing vehicle 100 upon such determination.

Further, the towing vehicle 100 includes a steering system 140 to steer the vehicle 100 in a desired direction. In the illustrated embodiment, the steering system 140 includes a front steering system 142 to steer the front wheels 122a and a rear steering system 144 for steering the rear wheels 122b. Further, the towing vehicle 100 includes a steering wheel 146 adapted to be rotated by a driver of the towing vehicle 100 to steer the front wheels 122a and/or the rear wheels 122b. It may be appreciated that the rear steering system 144 is arranged/configured to be selectively engaged with the rear wheels 122b for steering of the rear wheels 122b. Accordingly, the rear steering system 144 is operated or displaced between an engaged position and a free position. In the engaged position, the rear steering system 144 is engaged with the rear wheels 122b and therefore controls the steering of the rear wheels 122b, while in the free position, the rear steering system 144 remains disengaged from the rear wheels 122b and the rear wheels 122b are oriented such that they do not cause a change in direction of towing vehicle 100.

In some embodiments, the towing vehicle 100 may include a selector adapted to be operated by the driver to move the rear steering system 144 between the engaged position and the free position. In some embodiments, the rear steering system 144 is automatically moved between the engaged position and the free position depending on one or more operating parameters of the towing vehicle 100. For example, the rear steering system 144 may be moved to the engaged position to control the steering of the rear wheels 122b while reversing of the vehicle 100. In some scenarios, the rear steering system 144 is moved to the engaged position when the gear selector 138 is moved/displaced to the reverse gear position. In some embodiments, the rear steering system 144 is moved to the engaged position when a controller of the vehicle 100 detects an impending jack knifing of the trailer 106 relative to towing vehicle 100 to prevent a jack knife condition.

To prevent a jack knifing condition of the towing vehicle 100 and trailer 106, towing vehicle 100 includes a jackknife deterrent system 150. The deterrent system 150 includes at least one sensor, for example, at least one camera 152 and/or at least one parking sensor 154 arranged at the rear end 110 of the towing vehicle 100 and mounted to the vehicle body 120 to detect and monitor a distance 158 between front end portion 108 of the trailer 106 and the rear end 110 of the towing vehicle 100 and a turning direction of the towing vehicle 100 relative to the trailer 106. In some embodiments, the parking sensors 154 are included in a rear parking assist system of the towing vehicle 100. For example, the parking sensors 154 may include ultrasonic sensors positioned in or near a rear bumper of vehicle 100 and also used, when trailer 106 is not coupled to vehicle 100, to warn a driver when reversing vehicle 100 of a nearby object. Moreover, the camera 152 may be included in vehicle 100 and used as a part of a known reverse camera system, also referred to as a backup camera and/or a rear-view camera.

Further, the deterrent system 150 includes a controller 160 communicatively coupled to the at least one sensor i.e., the camera 152 and/or the parking sensors 154, the rear steering system 144, the gear selector 138, the steering wheel 146 and various other electrical and electronic system of the towing vehicle 100 to control the towing vehicle 100. In an embodiment, the controller 160 is configured determine the distance 158 based on the input received from the at least one sensor, the camera 152 and/or the parking sensors 154 and controls the rear steering system 144 of the towing vehicle 100 based on the distance 158. In some embodiments, the controller 160 is also configured to determine the turning direction of the towing vehicle 100 relative to the trailer 106 based on the input received from the at least one sensor i.e., camera 152 and/or the parking sensors 154, and control the rear steering system 144 accordingly, to prevent the jack knifing of the trailer 106.

In some embodiments, the controller 160 may be an electronic control module (ECM) of the towing vehicle 100. The controller 160 includes a processor 162 and a memory 164 to respectively process and store the data received from the at least one sensor and other electrical and electronic component of the towing vehicle 100. In some embodiments, the instructions to process the data and/or control the various components of the towing vehicle 100, for example, the at least one sensor, the steering wheel 146, the rear steering system 144, the mode selector 139, and any other electrical or electronic component of the towing vehicle 100 is stored inside the memory 164 of the controller 160.

The memory 164 may be integrated into the controller 160, but those skilled in the art will understand that the memory 164 may be separate from the controller 160 but onboard the towing vehicle 100, and/or remote from the controller 160 and the towing vehicle 100, while still being associated with and accessible by the controller 160 to store information in and retrieve information from the memory 164 as necessary during the operation of the towing vehicle 100 i.e., deterrent system 150, the rear steering system 144, the front steering system 142, the power source 130, etc. Although the processor 162 is contemplated, it is also possible and contemplated to use other electronic components such as a microcontroller, an application specific integrated circuit (ASIC) chip, or any other integrated circuit device. The processor 162 is configured to execute specified instructions, which controls and monitors various functions associated with power source 130, the deterrent system 150, the steering system 140, a braking system and respective components, and any other system or component of the towing vehicle 100, etc.

The processor 162 is configured to control the rear steering system 144 of the towing vehicle 100 based on an input received from the camera 152 and/or the parking sensors 154. In some embodiments, the processor 162 is configured to determine the distance 158 between the towing vehicle 100 and the trailer 106 based on the input received from the camera 152 and/or the parking sensors 154. In an embodiment, the processor 162 processes the images/video received from the camera 152 and determines a direction of turning of the towing vehicle 100 relative to the trailer 106. In some embodiments, the processor 162 may determine the distance 158 upon determining the turning direction of the towing vehicle 100 relative to trailer 106. It may be appreciated that a distance between the trailer 106 and the towing vehicle 100 on a first side of the hitch/pivot connection 166 of the trailer 106 and the towing vehicle 100 and a distance on the second side of the hitch/pivot connection 166 is substantially equal when the vehicle 100 is travelling in straight path. However, the distance on one of the sides of the hitch connection 166 increases, while the other sides of the hitch connection 166 decreases when towing vehicle 100 is turning relative to the trailer 106.

In some embodiments, optionally, or additionally, the processor 162 may use the input of the parking sensors 154 to determine the distance 158 and the turning direction of the towing vehicle 100 relative to the trailer 106. For example, in some embodiments, at least one first parking sensor 154a is arranged on a first side of the pivot/hitch connection 166 of the trailer 106 and the towing vehicle 100 and at least one second parking sensor 154b disposed on a second side of the pivot/hitch connection 166. In an embodiment the first parking sensor 154a monitors a distance of the towing vehicle 100 from the trailer 106 on the first side of the hitch connection 166, while the second parking sensor 154b monitors a distance of the towing vehicle 100 and the trailer 106 on the second side of the hitch connection 166. Accordingly, based on the inputs of the parking sensors 154 and/or the camera 152, the processor 162 determines the direction of turning and the distance 158 based on the distances measured by the parking sensors 154a, 154b. It may be appreciated that the processor 162 is configured to determine the smallest of the two distances measured on two sides of the hitch connection 166 as the distance 158 and monitors the distance 158. Also, in some embodiments, the processor 162 monitors the distance 158 and the direction of turning when the tow-trailer mode is active i.e., power source 130 is being operated in the tow-trailer mode.

Based on the distance 158, the processor 162 is configured to actuate the rear steering system 144 and control the rear steering system 144 to keep the distance 158 greater than or equal to a first threshold distance value. It may be appreciated that the processor 162 controls the rear steering system 144 independently of the front steering system 142 to maintain the distance 158 above or equal to the first threshold distance value. In some embodiments, the rear steering system 144 steers the rear wheels 122b in a direction opposite to a direction of steering of the front wheels 122a to prevent the jack knifing of the vehicle 100. Also, in some embodiments, the processor 162, before initiating the control of the rear steering system 144, may determines a position of the gear selector 138 to determine whether the reverse gear is engaged or one of the forward gears is engaged and controls the rear steering system 144 accordingly to maintain the distance 158 above or equal to the first threshold distance value, while enabling the desired turning or reversing of the vehicle 100.

It may be appreciated that the processor 162 may define or determine the first threshold distance value adaptively based on a speed of the towing vehicle 100 and/or a driving skill level of the driver of the towing vehicle 100. In some embodiments, deterrent system 150 includes an input device 170 configured to receive a user selection corresponding to a selected driving skill level of the driver. The input device 170 may be included within an existing user interface or input device of the towing vehicle 100, for example, an infotainment system touch screen, or any other input device that allows deterrent system 150 to function as described herein. The driving skill level may be determined based on a driver's profile stored inside the memory 164. It may be envisioned that, in some embodiments, the driver's profile is updated based on one or more driving characteristics/parameters of the driver determined and stored as the driver drives the vehicle 100. Accordingly, the driving skill level may change over time, and accordingly the controller 160 i.e., processor 162 may adaptively change the first threshold distance value for the driver.

For example, the processor 162 may categorize or assign the driver as a novice driver and accordingly keep the first threshold distance value as a relatively large value. However, the processor 162 may observe/determine that the driver's driving characteristics/parameters has improved over time and may change the driver's skill level to an intermediate level. In such a case, the processor 162 may change and reduce the first threshold distance value to a relatively smaller value. It may be appreciated that determining the skill level of driver based on the driving characteristics/parameters is known in the art. Also, the processor 162 may assign a relatively large value as the first threshold distance value when the speed during turning/reversing is relatively high and assigns a relatively small/low value as the first threshold distance value when the speed of reversing/turning is relatively low. In an embodiment, it may be envisioned that controller 160 may determine the first threshold distance value adaptively based on the driver's skill and/or the speed of the vehicle. A relatively higher first threshold distance value provides a higher level of jack knife deterrence which is useful for a driver with a lower skill level. However, a higher first threshold distance value may also restrict experienced drivers from making desired movements. Therefore, a jack knife deterrence system that is controlled based on a skill level of the driver is able to benefit drivers of all skill levels.

Further, the processor 162 is configured to start the monitoring the distance 158 as soon as the turning or reversing of the towing vehicle 100 relative to the trailer 106 is determined and keeps monitoring the distance 158 continuously, periodically, or intermittently during the turning and/or reversing of the vehicle 100. In some embodiments, processor 162 is configured to raise/generate an alert when the distance 158 becomes less than or equal to a second threshold distance value smaller than the first threshold distance value. To generate the alert, the towing vehicle 100 may include an audio alarm, for example, a horn, and/or a visual alarm, for example, a light, communicatively coupled to the controller 160, and configured to be actuated by the controller 160. In some embodiments, the controller 160 may generate the alert as a text message shared to a mobile phone, for example, a smartphone, of the user. Also, in some embodiments, the controller 160, upon determination that the distance 158 is less than the second threshold distance value, may apply brakes and/or shut down the power source 130 to prevent the driver to further move the vehicle 100. As with the first threshold distance value, it may be envisioned that the controller 160 may adaptively determine or define the second threshold distance value based on the speed of the vehicle 100 during reversing/turning and/or the driver's skill.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A jackknife deterrent system for a towing vehicle configured to be connected to a trailer, the towing vehicle includes rear wheels and a rear steering system to steer the rear wheels, the jackknife deterrent system comprising:
at least one sensor configured to detect a distance between the towing vehicle and the trailer; and
a controller communicatively coupled to the at least one sensor and the rear steering system of the towing vehicle and configured to:
monitor the distance between the towing vehicle and the trailer based on input received from the at least one sensor, and
control the rear steering system to control the steering of the rear wheels to keep the distance between the towing vehicle and the trailer equal to or above a first threshold distance value during turning of the towing vehicle relative to the trailer.

2. The jackknife deterrent system of claim 1 further comprising an input device configured to receive a skill level selection from a driver driving the towing vehicle.

3. The jackknife deterrent system of claim 2, wherein the controller is configured to determine the first threshold distance value based on the skill level selection.

4. The jackknife deterrent system of claim 3, wherein the controller is configured to apply a shorter first threshold distance value when a high skill level is selected than when a low skill level is selected.

5. The jackknife deterrent system of claim 1, wherein the at least one sensor includes at least one of a camera and a vehicle parking sensor.

6. The jackknife deterrent system of claim 1, wherein the controller is configured to control the rear steering system when a tow-trailer mode of the towing vehicle is active.

7. The jackknife deterrent system of claim 1, wherein the controller is configured to generate an alert when the distance between the towing vehicle and the trailer is equal to or less than a second threshold distance value, wherein the second threshold distance value is smaller than the first threshold distance value.

8. The jackknife deterrent system of claim 7, the alert is at least one of an audio alert, a visual alert, and a notification shared to a smart phone.

9. A towing vehicle configured to be connected to a trailer to tow the trailer, the towing vehicle comprising:
a rear steering system to steer rear wheels of the towing vehicle;
at least one sensor configured to detect a distance between the towing vehicle and the trailer; and
a controller communicatively coupled to the at least one sensor and the rear steering system of the towing vehicle and configured to:
monitor the distance between the towing vehicle and the trailer based on input received from the at least one sensor, and
control the rear steering system to control the steering of the rear wheels to keep the distance between the towing vehicle and the trailer equal to or above a first threshold distance value during turning of the towing vehicle relative to the trailer.

10. The towing vehicle of claim 9 further comprising an input device configured to receive a skill level selection from a driver driving the towing vehicle.

11. The towing vehicle of claim 10, wherein the controller is configured to:
determine the first threshold distance value based on the skill level selection, and
apply a shorter first threshold distance value when a high skill level is selected than when a low skill level is selected.

12. The towing vehicle of claim 9, further comprising a rear parking assist system, and wherein the at least one sensor includes a vehicle parking sensor included within the rear parking assist system.

13. The towing vehicle of claim 9, further comprising a reverse camera system, and wherein the at least one sensor includes a backup camera included within the reverse camera system.

14. The towing vehicle of claim 9, wherein controller is configured to control the rear steering system when a tow-trailer mode of the towing vehicle is active.

15. The towing vehicle of claim 9, wherein the controller is configured to generate an alert when the distance between towing vehicle and the trailer is equal to or less than a second threshold distance value, wherein the second threshold distance value is smaller than the first threshold distance value.

16. The towing vehicle of claim 15, wherein the controller is configured to determine the second threshold distance value based a skill level of a driver driving the towing vehicle.

17. The towing vehicle of claim 15, the alert is at least one of an audio alert, a visual alert, and a notification shared to a smart phone.

18. The towing vehicle of claim 9, wherein the controller is configured to determine a reversing of the towing vehicle and to control the rear steering system to steer the rear wheels during reversing of the towing vehicle to maintain the distance equal to or above the first threshold distance value.

19. A method for preventing a jackknifing of a towing vehicle and a trailer connected to the towing vehicle, the method comprising:
detecting, by at least one sensor, a distance between the towing vehicle and the trailer;
monitoring, by a controller, the distance between the towing vehicle and the trailer based on input received from the at least one sensor; and
controlling a rear steering system of the towing vehicle to control the steering of rear wheels of the towing vehicle to keep the distance between the towing vehicle and the trailer equal to or above a first threshold distance value during turning of the towing vehicle relative to the trailer.

20. The method of claim 19 further comprising
determining, by the controller, the first threshold distance value based on the skill level selection, and
applying, by the controller, a shorter first threshold distance value when a high skill level is selected than when a low skill level is selected.
